(19) United States
(12) Patent Application Publication
(10) Pub. No.: US 2025/0007618 A1
(43) Pub. Date: Jan. 2, 2025

(54) POLARIZATION FLUCTUATION MONITORING APPARATUS, COMMUNICATION SYSTEM, POLARIZATION FLUCTUATION MONITORING METHOD, AND PROGRAM

(71) Applicant: NEC Corporation, Tokyo (JP)

(72) Inventor: Yusuke SASAKI, Tokyo (JP)

(73) Assignee: NEC Corporation, Tokyo (JP)

(21) Appl. No.: 18/582,864

(22) Filed: Feb. 21, 2024

(30) Foreign Application Priority Data
Jun. 29, 2023 (JP) 2023-106756

(51) Int. Cl. H04B 10/61; G01J 4/04; H04B 10/079; H04J 14/06

(52) U.S. Cl. CPC H04B 10/6162; G01J 4/04; H04B 10/0795; H04J 14/06

(57) ABSTRACT

A light source outputs an optical signal to a transmission line. A polarization characteristic measuring unit measures a polarization characteristic of an optical signal transmitted through the transmission line. A Fourier transform unit Fourier-transforms the polarization characteristic measured by the polarization characteristic measuring unit. A fluctuation estimation unit estimates a polarization fluctuation frequency occurring in the transmission line, based on the polarization characteristics Fourier-transformed by the Fourier transform unit.

### INCORPORATION BY REFERENCE

This application is based upon and claims the benefit of priority from Japanese patent application No. 2023-106756, filed on Jun. 29, 2023, the disclosure of which is incorporated herein in its entirety by reference.

### TECHNICAL FIELD

The present disclosure relates to a polarization fluctuation monitoring apparatus, a communication system, a polarization fluctuation monitoring method, and a program.

### BACKGROUND ART

In order to achieve an increase in capacity of communication systems, polarization multiplexing digital coherent communication has been introduced. In the polarization multiplexing digital coherent communication, state of polarization (SOP) fluctuation may occur in a transmitted signal. Factors that lead to SOP fluctuation include factors such as construction vibration, lightning, car traffic, an earthquake, and wind. When a rapid SOP fluctuation occurs, polarization compensation in equalization processing cannot follow the polarization fluctuation, which may lead to an error. Therefore, a monitoring system that monitors the polarization fluctuation that causes an error and detects the polarization fluctuation is important.

As a related art, Japanese Unexamined Patent Application Publication No. 2020-134161 discloses a method of estimating a polarization fluctuation location. In Japanese Unexamined Patent Application Publication No. 2020-134161, a light source sequentially outputs different signal lights to an optical fiber in an identifiable manner. An acquisition unit acquires, for each piece of signal light, a polarization state of each piece of signal light from scattered light in the optical fiber with respect to the signal light. The acquisition unit acquires, for example, Stokes parameters S0, S1, S2, and S3 as polarization states. An estimation unit converts a time-associated polarization state for each piece of acquired signal light into a polarization state associated to a distance at which a reflection point of the scattered light in the optical fiber can be identified, and estimates a point at which the polarization state fluctuates from the polarization state associated to a distance after the conversion, as a polarization fluctuation location.

As another related art, Non-Patent Literature 1 (J. E. Simsarian and P. J. Winzer, “Shake Before Break: Per Span Fiber Sensing with In Line Polarization Monitoring”, OFC2017, M2E.6.) discloses an in-line polarization monitoring scheme. In Non-Patent Literature 1, an optical supervisory channel (OSC) is used for monitoring a polarization state. The OSC is generally implemented with an optical signal with a wavelength of 1510 nm outside a band of a main signal. The OSC optical signal is inserted into the optical fiber and extracted from the optical fiber for every span. The OSC optical signal is separated into two optical signals by using a polarizing beam splitter, and the two separated optical signals are detected by using two photodetectors, respectively. A processing unit calculates a polarization rotation speed, based on a difference between detection signals of the two photodetectors.

Non-Patent Literature 1 discloses a result of comparing the polarization rotation speed calculated based on the difference between the detection signals of the two photodetectors, a polarization rotation speed calculated from Stokes parameters S1 to S3, and a polarization rotation speed calculated from two Stokes parameters. As described in Non-Patent Literature 1, the polarization rotation speed calculated based on the difference between the detection signals of the two photodetectors is less accurate than the polarization rotation speed calculated from the Stokes parameters S1 to S3. The polarization rotation speed calculated based on the two Stokes parameters is also less accurate than the polarization rotation speed calculated from the Stokes parameters S1 to S3. However, when the polarization rotation speed is calculated from the Stokes parameters S1 to S3, although accuracy of the polarization rotation speed is high, there is a problem that the calculation is complicated.

### SUMMARY

In view of the above-described circumstances, an object of the present disclosure is to provide a polarization fluctuation monitoring apparatus, a communication system, a polarization fluctuation monitoring method, and a program that are capable of accurately estimating a polarization fluctuation frequency without requiring complicated calculation.

The present disclosure provides a polarization fluctuation monitoring apparatus including a polarization characteristic measuring unit configured to measure a polarization characteristic of an optical signal transmitted through a transmission line, a Fourier transform unit configured to Fourier-transform the measured polarization characteristic, and a fluctuation estimation unit configured to estimate a polarization fluctuation frequency occurring in the transmission line, based on the Fourier-transformed polarization characteristic.

The present disclosure provides a communication system including a transmitter configured to transmit a polarization multiplexed signal, a receiver configured to receive a polarization multiplexed signal transmitted from the transmitter via a transmission line, the polarization fluctuation monitoring apparatus, and a light source configured to output the optical signal to the transmission line.

The present disclosure provides a polarization fluctuation monitoring method including measuring a polarization characteristic of an optical signal transmitted through a transmission line, Fourier-transforming the measured polarization characteristic, and estimating a polarization fluctuation frequency occurring in the transmission line, based on the Fourier-transformed polarization characteristic.

The present disclosure provides a program for causing a computer to execute processing of acquiring a polarization characteristic of an optical signal transmitted through a transmission line, Fourier-transforming the acquired polarization characteristic, and estimating a polarization fluctuation frequency occurring in the transmission line, based on the Fourier-transformed polarization characteristic.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram schematically illustrating a communication system according to the present disclosure;

FIG. 2 is a block diagram illustrating a configuration example of a first communication system according to the present disclosure;

FIG. 3 is a block diagram illustrating a configuration example of an optical transmitter;

FIG. 4 is a block diagram illustrating a configuration example of an optical receiver;

FIG. 5 is a block diagram illustrating a configuration example of a digital signal processing unit;

FIG. 6 is a block diagram illustrating a configuration example of a polarization fluctuation monitoring apparatus;

FIG. 7 is a block diagram illustrating a system used in an experiment;

FIG. 8 is a graph illustrating a FFT waveform of a Stokes parameter S1;

FIG. 9 is a graph illustrating a FFT waveform of a Stokes parameter S2;

FIG. 10 is a graph illustrating a FFT waveform of a Stokes parameter S3;

FIG. 11 is a graph illustrating a FFT waveform of a Stokes parameter S1;

FIG. 12 is a graph illustrating a FFT waveform of the Stokes parameter S1;

FIG. 13 is a flowchart illustrating an operation procedure of the polarization fluctuation monitoring apparatus;

FIG. 14 is a block diagram illustrating a configuration example of a Stokes parameter measuring apparatus;

FIG. 15 is a block diagram illustrating a configuration example of a polarization fluctuation monitoring apparatus used in a second communication system according to the present disclosure;

FIG. 16 is a graph illustrating the FFT waveform of the Stokes parameter S1 acquired in an experiment; and

FIG. 17 is a block diagram illustrating a configuration example of a computer apparatus.

### EXAMPLE EMBODIMENT

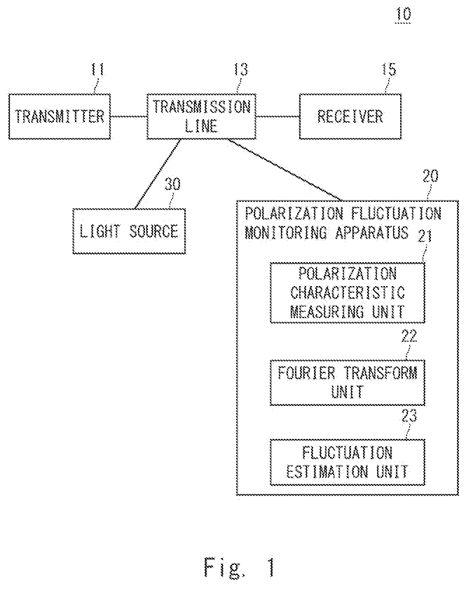

Prior to explanation of example embodiments of the present disclosure, an outline of the present disclosure will be explained. FIG. 1 schematically illustrates a communication system according to the present disclosure. The communication system 10 includes a transmitter 11, a receiver 15, a polarization fluctuation monitoring apparatus 20, and a light source 30. The transmitter 11 and the receiver 15 are connected to each other via a transmission line 13. The transmitter 11 outputs a polarization multiplexed signal to the transmission line 13. The receiver 15 receives the polarization multiplexed signal transmitted from the transmitter 11 via the transmission line 13.

The light source 30 outputs an optical signal used for monitoring a polarization state to the transmission line. The optical signal being output from the light source 30 is inserted into the transmission line 13 by using, for example, a multiplexer, and branched from the transmission line 13 by using a filter. The optical signal being output from the light source 30 is transmitted through at least a part of the transmission line, and is input to the polarization fluctuation monitoring apparatus 20.

The polarization fluctuation monitoring apparatus 20 includes a polarization characteristic measuring unit 21, a Fourier transform unit 22, and a fluctuation estimation unit 23. The polarization characteristic measuring unit 21 measures a polarization characteristic of the optical signal being output from the light source 30 and transmitted through the transmission line. The Fourier transform unit 22 Fourier-transforms the measured polarization characteristics. The fluctuation estimation unit 23 estimates a polarization fluctuation frequency occurring in the transmission line 13, based on the Fourier-transformed polarization characteristic.

In the present disclosure, the Fourier transform unit 22 performs a Fourier transform on the polarization characteristic measured by the polarization characteristic measuring unit 21. The fluctuation estimation unit 23 estimates the polarization fluctuation frequency, based on the Fourier-transformed polarization characteristic. In the present disclosure, a Fourier transform is used to estimate the polarization fluctuation frequency, and the polarization fluctuation monitoring apparatus 20 according to the present disclosure can estimate the polarization fluctuation frequency from a waveform of the Fourier-transformed polarization characteristic without calculating all of Stokes parameters. Therefore, the polarization fluctuation monitoring apparatus 20 can accurately estimate the polarization fluctuation frequency without requiring complicated calculation.

Hereinafter, example embodiments of the present disclosure will be explained in detail. Note that the following description and the drawings are omitted and simplified as appropriate for clarity of explanation. In the drawings, the same elements and the similar elements are denoted by the same reference numerals, and redundant explanations are omitted as necessary.

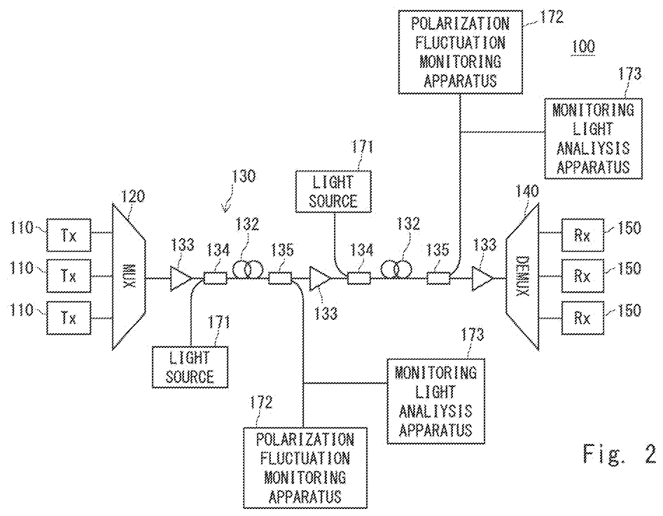

A first example embodiment of the present disclosure will be explained. FIG. 2 illustrates a configuration example of a first communication system according to the present disclosure. In the present example embodiment, it is assumed that the communication system is an optical fiber communication system that employs a polarization multiplexing multilevel modulation scheme and performs coherent reception. Further, it is assumed that the communication system is a communication system in which optical signals having a plurality of wavelengths are multiplexed in a Wavelength Division Multiplexing (WDM) scheme. The multiplexing scheme is not limited to the WDM scheme, and a plurality of optical signals may be multiplexed by a spatial multiplexing scheme.

An optical fiber communication system 100 includes a plurality of optical transmitters 110, a multiplexer 120, a transmission line 130, a demultiplexer 140, and a plurality of optical receivers 150. The optical fiber communication system 100 constitutes, for example, a terrestrial metro communication system or an optical submarine cable system. The optical fiber communication system 100 is associated to the communication system 10 illustrated in FIG. 1.

The optical transmitter 110 converts a plurality of transmission data into a polarization multiplexed signal. The multiplexer 120 multiplexes a plurality of polarization multiplexed signals being output from the plurality of optical transmitters 110. The transmission line 130 transmits the optical signal being output from the multiplexer 120 to the optical receiver 150. The optical transmitter 110 is also referred to as Tx. The optical transmitter 110 is associated to the transmitter 11 illustrated in FIG. 1.

The transmission line 130 includes an optical fiber 132 and an optical amplifier 133. The optical fiber 132 guides an optical signal transmitted from the optical transmitter 110. The optical amplifier 133 amplifies the optical signal and compensates for propagation loss in the optical fiber 132. The optical amplifier 133 is configured, for example, as an erbium doped fiber amplifier (EDFA). The transmission line 130 is associated to the transmission line 13 illustrated in FIG. 1.

The demultiplexer 140 demultiplexes the polarization multiplexed signal being multiplexed by the WDM, and converts the polarization multiplexed signal being multiplexed by the WDM into a plurality of polarization multiplexed signals. The demultiplexer 140 outputs the plurality of polarization multiplexed signals to the plurality of optical receivers 150. Each of the optical receivers 150 receives a polarization multiplexed signal transmitted from an associated optical transmitter 110. The optical receiver 150 is also referred to as Rx. The optical receiver 150 is associated to the receiver 15 illustrated in FIG. 1.

Although FIG. 2 illustrates an example in which the optical fiber communication system 100 includes three optical transmitters 110 and three optical receivers 150, the number of the optical transmitters 110 and the optical receivers 150 is not limited to three. Although FIG. 2 illustrates an example in which the transmission line 130 includes three optical amplifiers 133, the number of the optical amplifiers 133 in the transmission line 130 is not limited to three.

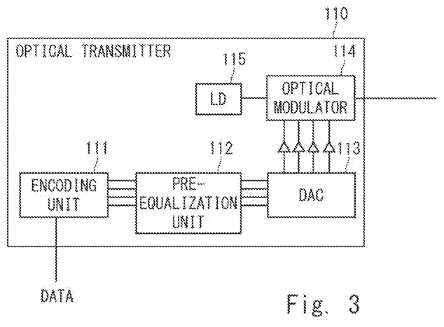

FIG. 3 illustrates a configuration example of the optical transmitter 110. The optical transmitter 110 includes an encoding unit 111, a pre-equalization unit 112, a digital analog converter (DAC) 113, an optical modulator 114, and a laser diode (LD) 115. The encoding unit 111 encodes data. The encoding unit 111 outputs, for example, four sequences of signals which are in-phase (I) components and quadrature (Q) components of X polarization and Y polarization.

The pre-equalization unit 112 performs pre-equalization to compensate, for example, distortion of a device in the optical transmitter in advance for the four sequences of encoded signals. The pre-equalization unit 112 includes, for example, multiple-input and multiple-output (MIMO) filters having I component and Q component as input and output for each polarization. The MIMO filter compensates for distortion occurring in the I component and Q component in each polarization and distortion occurring in the optical transmitter 110, such as crosstalk occurring between the IQ.

The DAC 113 converts the four sequences of signals on which pre-equalization has been performed into analog electrical signals. The DAC 113 inputs the converted analog electrical signal to the optical modulator 114. An electric amplifier is arranged between the DAC 113 and the optical modulator 114, and an analog electric signal whose amplitude is amplified by the electric amplifier is input to the optical modulator 114.

The LD 115 outputs continuous wave (CW) lights. The optical modulator 114 is a modulator that modulates the CW lights being output from the LD 115 in accordance with four sequences of analog electric signals being input from the DAC 113, and that generates a polarization multiplexed signal such as a polarization multiplexed quadrature-amplitude modulation (QAM) signal. The optical modulator 114 includes, for example, a Mach-Zehnder (MZ) modulator. The optical modulator 114 outputs the generated polarization multiplexed signal to the multiplexer 120.

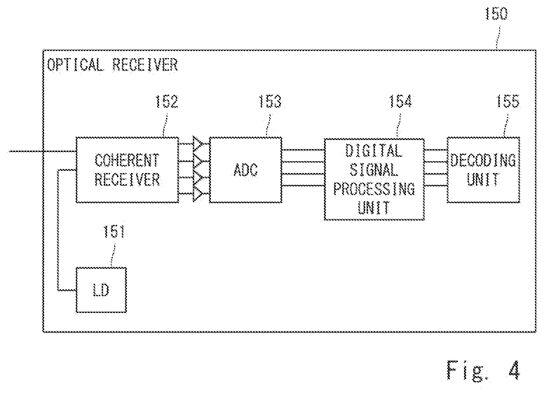

FIG. 4 illustrates a configuration example of the optical receiver 150. The optical receiver 150 includes an LD 151, a coherent receiver 152, an analog digital converter (ADC) 153, a digital signal processing unit 154, and a decoding unit 155. The LD 151 outputs CW light that becomes local oscillator light. The coherent receiver 152 is configured as a polarization diversity coherent receiver. The coherent receiver 152 performs coherent detection on the optical signal transmitted through the optical fiber 132 by using the CW light being output from the LD 151. The coherent receiver 152 outputs four sequences of received signals (electric signals) equivalent to the I component and the Q component of the coherently detected X polarization and Y polarization.

The received signal being output from the coherent receiver 152 is input to the ADC 153 via an electric amplifier. The ADC 153 samples the received signal being output from the coherent receiver 152 and converts the received signal into a digital signal. The ADC 153 outputs the converted digital signal to the digital signal processing unit 154. The digital signal processing unit 154 performs digital signal processing on the four sequences of received signals sampled by the ADC 153 and demodulates the received signals. The digital signal processing unit 154 includes an equalization filter, and the equalization filter compensates for various distortions included in the digital signal.

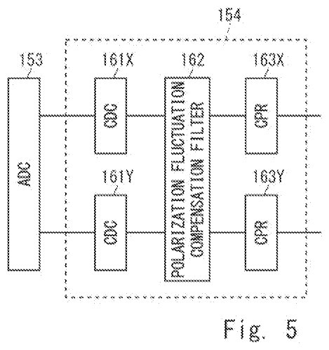

FIG. 5 illustrates a configuration example of the digital signal processing unit 154. The digital signal processing unit 154 includes chromatic dispersion compensation (CDC) filters 161X and 161Y and carrier phase compensation filters 163X and 163Y, which are arranged for the X and Y polarizations, respectively. Further, the digital signal processing unit 154 includes a polarization fluctuation compensation filter 162.

Complex number data of the X polarization and complex number data of the Y polarization, which are output from the ADC 153, are input to the digital signal processing unit 154, the complex number data of the X polarization and the complex number data of the Y polarization being acquired by converting the IQ component of the X polarization and the IQ component of the Y polarization into complex number signals, respectively. In the digital signal processing unit 154, the CDC filters 161X and 161Y, the polarization fluctuation compensation filter 162, and the carrier phase compensation filters 163X and 163Y are connected in tandem to an input signal. These filters constitute an adaptive multi-layer filter.

The CDC filters 161X and 161Y compensate for signal distortion caused by chromatic dispersion during optical fiber transmission for each polarization. The coefficients of the CDC filters 161X and 161Y are set based on a physical model of distortion caused by chromatic dispersion and the like. The distortion caused by the chromatic dispersion is fixed, and the CDC filters 161X and 161Y are treated as static filters.

The polarization fluctuation compensation filter 162 is configured as a complex coefficient MIMO filter having a complex number signal 2 inputs and 2 outputs. The polarization fluctuation compensation filter 162 compensates for signal distortion caused by polarization state fluctuations and dispersion of polarization modes during optical fiber transmission. The carrier phase compensation filters 163X and 163Y compensate for signal distortion caused by a frequency offset and a phase offset between a carrier of the transmitted optical signal and local oscillator light on a receiving side. For the carrier phase compensation filters 163X and 163Y, for example, an SL 1×1 1 tapped Finite Impulse Response (FIR) filter is used. The carrier phase compensation filters 163X and 163Y are also referred to as carrier phase recovery (CPR) filters.

The digital signal processing unit 154 outputs a signal acquired by compensating for various distortions to the decoding unit 155. The decoding unit 155 decodes the input signal and restores the transmitted data. The decoding unit 155 is also referred to as a decoder. In the optical receiver 150, circuitry such as the digital signal processing unit 154 and the decoding unit 155 may be configured using a device such as a digital signal processor (DSP).

Returning to FIG. 2, the optical fiber communication system 100 includes, in addition to the above-described components, a light source 171, a polarization fluctuation monitoring apparatus 172, and a monitoring light analysis apparatus 173. The optical fiber communication system 100 may include a plurality of sets of light sources 171, a polarization fluctuation monitoring apparatus 172, and a monitoring light analysis apparatus 173. The optical fiber communication system 100 includes, for example, a set of a light source 171, a polarization fluctuation monitoring apparatus 172, and a monitoring light analysis apparatus 173 for each predetermined span in the transmission line 130. In the example of FIG. 2, the optical fiber communication system 100 has one set of a light source 171, a polarization fluctuation monitoring apparatus 172, and a monitoring light analysis apparatus 173 for each span partitioned by two adjacent optical amplifiers 131.

The light source 171 outputs an optical signal having a predetermined wavelength. The light source 171 outputs a main signal, i.e., an optical signal having a wavelength different from the wavelength of the polarization multiplexed signal to be output from the plurality of optical transmitters 110. In the present example embodiment, the light source 171 outputs an optical signal having a wavelength of 1510 nm. The optical signal to be output from the light source 171 is also referred to as an OSC signal or a monitoring optical signal used for operation setting in the transmission line and state monitoring of the transmission line. In the present example embodiment, the optical signal to be output from the light source 171 is also used for monitoring the polarization state. The optical signal to be output from the light source 171 is inserted into the optical fiber 132 via a multiplexer 134 such as an optical coupler. The optical signal inserted into the optical fiber 132 from the light source 171 may undergo polarization fluctuation during transmission of the optical fiber 132. The light source 171 is associated to the light source 30 illustrated in FIG. 1.

The optical signal inserted into the optical fiber 132 from the light source 171 is selectively branched from the optical fiber 132 to the polarization fluctuation monitoring apparatus 172 and the monitoring light analysis apparatus 173 by using a demultiplexer 135 such as a wavelength demultiplexer or a wavelength selective switch. The polarization fluctuation monitoring apparatus 172 and the monitoring light analysis apparatus 173 receive an optical signal having a wavelength of 1510 nm, for example, which is output from the light source 171. The monitoring light analysis apparatus 173 monitors whether there is any change in loss of the transmission line. The monitoring light analysis apparatus 173 operates an optical amplifier 133 such as an EDFA. The polarization fluctuation monitoring apparatus 172 monitors the polarization fluctuation in the optical fiber 132 by using an input optical signal.

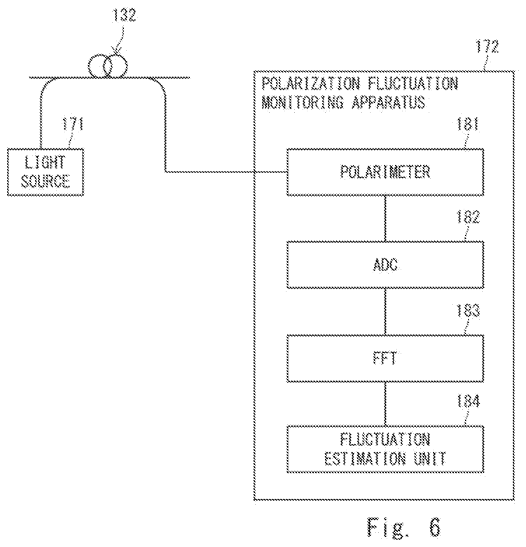

FIG. 6 illustrates a configuration example of the polarization fluctuation monitoring apparatus 172. The polarization fluctuation monitoring apparatus 172 includes a polarimeter 181, an ADC 182, Fast Fourier Transformation (FFT) 183, and a fluctuation estimation unit 184. The polarization fluctuation monitoring apparatus 172 may be physically configured as an apparatus having one or more processors and one or more memories. At least a part of functions of the units of the polarization fluctuation monitoring apparatus 172 may be achieved by one or more processors operating in accordance with a program read from one or more memories. The polarization fluctuation monitoring apparatus 172 is associated to the polarization fluctuation monitoring apparatus 20 illustrated in FIG. 1.

The polarimeter 181 measures a polarization characteristic of an input optical signal. In the present example embodiment, the polarimeter 181 calculates the Stokes parameters S0 to S3. The Stokes parameters S0 to S3 are expressed by the following equations using electric field information of the X polarization and the Y polarization as E₀ₓ and E_{0y}.

$$\begin{matrix}S 0 = {E}_{ox}^{2} + {E}_{oy}^{2} \\ S 1 = {E}_{ox}^{2} - {E}_{oy}^{2} \\ S 2 = 2 {E}_{ox} 2 {E}_{oy} cos φ \\ S 3 = 2 {E}_{ox} 2 {E}_{oy} sin φ\end{matrix}$$

The Stokes parameter S0 is associated to the overall intensity. The Stokes parameter S1 is associated to a difference between a horizontal component and a vertical component of linear polarization light. The Stokes parameter S2 is associated to a 45 degree linear polarization component. The Stokes parameter S3 is associated to a circular polarization component.

The polarimeter 181 outputs one or more of the Stokes parameters S1 to S3 to the ADC 182. The polarimeter 181 outputs, for example, the Stokes parameter S1 to the ADC 182. Note that the polarimeter 181 does not necessarily need to calculate all of the above-described Stokes parameters S0 to S3. For example, the polarimeter 181 may calculate only one of the Stokes parameters S1 to S3. The polarimeter 181 is associated to the polarization characteristic measuring unit 21 illustrated in FIG. 1.

The ADC 182 converts the Stokes parameter being output from the polarimeter 181 into a digital signal. The ADC 182 converts the stokes parameter being output in time series into a digital signal, and outputs the digital signal to the FFT 183 in time series. The FFT 183 performs an FFT on one of the Stokes parameters converted into a digital signal, and converts one of the Stokes parameters into a signal in a frequency domain. The FFT 183 is associated to the Fourier transform unit 22 illustrated in FIG. 1.

The fluctuation estimation unit 184 estimates a characteristic of the polarization state, based on one of the Stokes parameters converted into a signal in the frequency domain by the FFT 183. In the present example embodiment, the fluctuation estimation unit 184 estimates a polarization fluctuation frequency, i.e., a polarization fluctuation speed, as a characteristic of the polarization state. The fluctuation estimation unit 184 searches for a peak in one of the Stokes parameters converted into, for example, a signal in the frequency domain, i.e., in one FFT waveform of the Stokes parameter. When the peak is searched, the fluctuation estimation unit 184 estimates a frequency at a position of the peak as the polarization fluctuation speed. The fluctuation estimation unit 184 is associated to the fluctuation estimation unit 23 illustrated in FIG. 1.

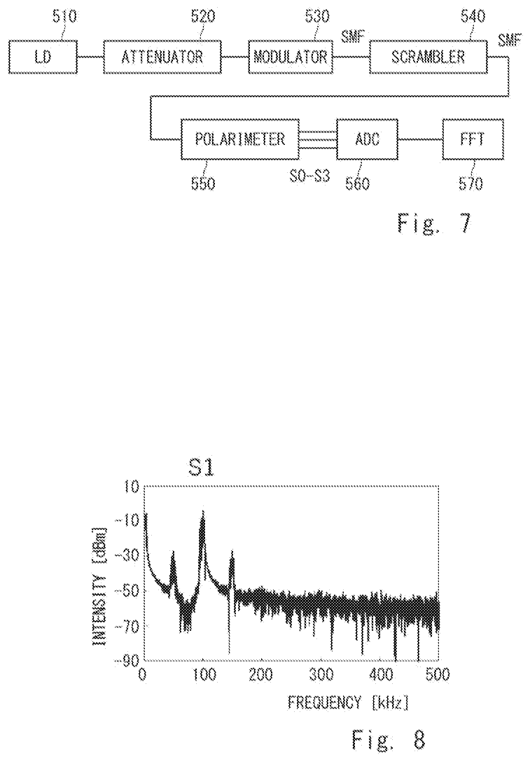

The present inventor has conducted experiments in order to confirm that the polarization fluctuation speed can be estimated from the FFT waveform of the Stokes parameter. FIG. 7 illustrates a system used in the experiment. The LD 510 emits a laser beam having a wavelength of 1510 nm. The attenuator 520 attenuates the laser light emitted from the LD 510 in order to adjust the received light power of the polarimeter 550. The modulator 530 modulates the laser beam being output from the LD 510 by on-off Non Return to Zero (NRZ) modulation of 156 MHz.

The laser beam modulated by the modulator 530, i.e., an optical signal is input to the scrambler 540 via a single-mode optical fiber (SMF: Single Mode Fiber). The scrambler 540 imparts polarization fluctuation to the optical signal at any frequency. The optical signal to which the polarization fluctuation is imparted by the scrambler 540 is input to the polarimeter 550 via the SMF.

The polarimeter 550 calculates the Stokes parameters SI to S3 for the input optical signal. The ADC 560 converts each of the Stokes parameters S1 to S3 from an analog signal to a digital signal. The FFT 570 performs a fast Fourier Transform on one of the Stokes parameters S1 to S3.

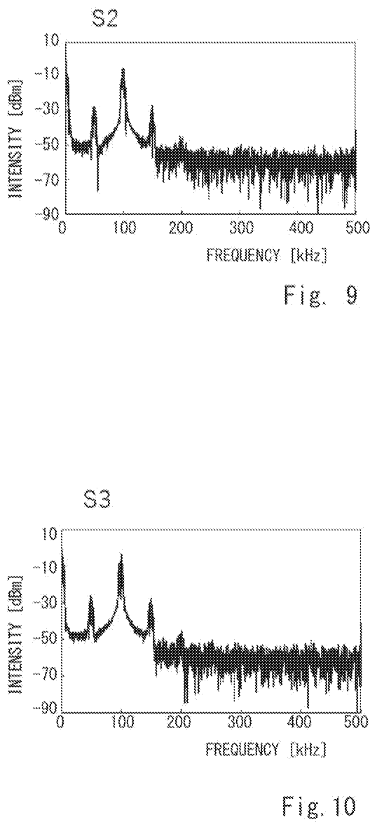

FIG. 8 illustrates a FFT waveform of the Stokes parameter S1. FIG. 9 illustrates a FFT waveform of the Stokes parameter S2. FIG. 10 illustrates a FFT waveform of the Stokes parameter S3. In graphs illustrated in FIGS. 8 to 10, each horizontal axis represents a frequency [kHz] and each vertical axis represents intensity [dBm]. In the experiment, the scrambler 540 has imparted a polarization fluctuation of 100 kHz to the optical signal.

As a result of the experiment, as illustrated in FIGS. 8 to 10, it has been confirmed that a peak is observed at a position of 100 kHz in the FFT waveform in any of the Stokes parameters S1 to S3. Therefore, it has been confirmed that a fast Fourier transform of one of the Stokes parameters S1 to S3 can estimate the fluctuation frequency of the polarization state, i.e., the polarization fluctuation speed.

Herein, in the optical fiber communication system 100 illustrated in FIG. 2, the power of the optical signal inserted into the optical fiber 132 is desirably lower in order to suppress interference between the optical signal inserted into the optical fiber 132 from the light source 171 and the main signal. In the system illustrated in FIG. 7, the present inventor has adjusted an attenuation amount of the attenuator 520 and examined how much received light power can be used to estimate the polarization fluctuation speed in the polarimeter 550.

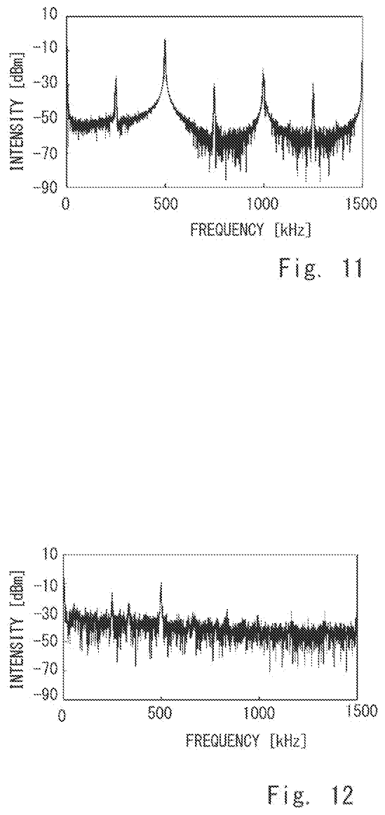

FIG. 11 illustrates the FFT waveform of the Stokes parameter S1 when the received light power in the polarimeter 550 is −5 dBm. FIG. 12 illustrates the FFT waveform of the Stokes parameter S1 when the received light power in the polarimeter 550 is −40 dBm. In graphs illustrated in FIGS. 11 and 12, each horizontal axis represents a frequency [kHz], and each vertical axis represents intensity [dBm]. In the experiment, the scrambler 540 has imparted a polarization fluctuation of 500 kHz to the optical signal.

As illustrated in FIG. 11, a peak has been observed at a position of 500 KHz in the FFT waveform of the Stokes parameter S1. Further, as illustrated in FIG. 12, even when the received light power is-40 dBm, a peak has been observed at a position of 500 KHz in the FFT waveform of the Stokes parameter S1. Therefore, in the optical fiber communication system 100 illustrated in FIG. 3, it is considered that the polarization fluctuation speed can be estimated when the received light power in the polarimeter 181 is −40 dBm or more. When the received light power is set low, it is possible to suppress deterioration in reception quality of the main signal caused by the optical signal inserted from the light source 171 into the optical fiber 132.

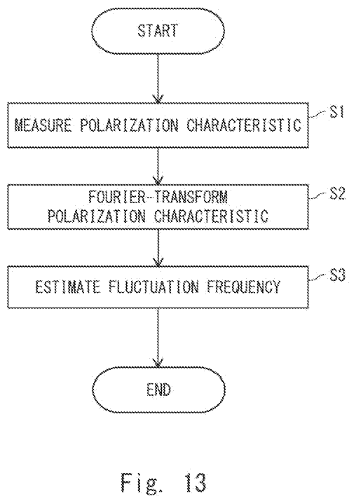

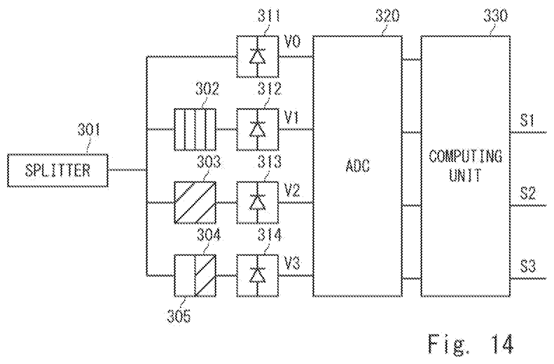

Next, an operation procedure will be explained. FIG. 13 illustrates an operation procedure of the polarization fluctuation monitoring apparatus 172. The operation procedure of the polarization fluctuation monitoring apparatus 172 is associated to a polarization fluctuation monitoring method. The light source 171 inserts an optical signal having a wavelength of, for example, 1510 nm into the optical fiber 132. The polarimeter 181 measures the polarization characteristic of the optical signal having the wavelength of 1510 nm transmitted through the optical fiber 132 (step S1). In step S1, the polarimeter 181 measures one of the Stokes parameters S1 to S3.

The ADC 182 converts the signal indicating the polarization characteristic measured in step S1 into a digital signal. The ADC 182 converts, for example, one of the Stokes parameters being output from the polarimeter 181 into a digital signal, and outputs the converted digital signal to the FFT 183. The FFT 183 performs Fourier transform on the digital signal indicating the measured polarization characteristic, which is input from the ADC 182 (step S2). In step S2, the FFT 183 performs a fast Fourier transform on the Stokes parameter S1, for example.

The fluctuation estimation unit 184 estimates the polarization fluctuation frequency, i.e., the polarization fluctuation speed, based on the Fourier-transformed polarization characteristic (step S3). In step S3, the fluctuation estimation unit 184 estimates, for example, a frequency indicating a peak in the FFT waveform of the Stokes parameter S1 as a polarization fluctuation frequency. The fluctuation estimation unit 184 may integrate the intensity of the peak frequency in the FFT waveform in a time direction and estimate a fluctuation amount of the polarization characteristic at the estimated polarization fluctuation frequency.

In the present example embodiment, the FFT 183 FFTs one of the Stokes parameters measured by the polarimeter 181. The fluctuation estimation unit 184 estimates the polarization fluctuation frequency from one FFT waveform of the Stokes parameter. For example, the fluctuation estimation unit 184 estimates the frequency of the peak position in the FFT waveform as the polarization fluctuation frequency. In the present example embodiment, the polarization fluctuation monitoring apparatus 172 can estimate the polarization fluctuation frequency from one FFT waveform of the Stokes parameters S1 to S3 without using all of the Stokes parameters S1 to S3.

In comparison with Non-Patent Literature 1, in Non-Patent Literature 1, a polarization fluctuation frequency is calculated based on a difference between detection signals of two photodetectors. In this case, although the calculation can be simplified, the accuracy of the calculated polarization fluctuation frequency is low. In Non-Patent Literature 1, in a case where the polarization fluctuation frequency is calculated from two Stokes parameters, similarly, although the calculation can be simplified, the accuracy of the calculated polarization fluctuation frequency is low. In contrast, the polarization fluctuation monitoring apparatus 172 according to the present example embodiment uses one FFT waveform of the Stokes parameter for estimating the polarization fluctuation frequency. The polarization fluctuation monitoring apparatus 172 according to the present example embodiment can estimate the polarization fluctuation frequency with high accuracy while simplifying the calculation by reducing the number of Stokes parameters to be used for estimating the polarization fluctuation frequency.

In the present example embodiment, the optical fiber communication system 100 includes a set of the light source 171 and the polarization fluctuation monitoring apparatus 172 for each predetermined section in the transmission line 130. In this case, presence or absence of polarization fluctuation and the polarization fluctuation frequency can be monitored for each section. Therefore, a user of the polarization fluctuation monitoring apparatus 172 can know in which section, what kind of frequency polarization fluctuation has occurred.

In the present example embodiment, the polarization fluctuation monitoring apparatus 172 may control the coefficient of the polarization fluctuation compensation filter 162 (see FIG. 5) included in the digital signal processing unit 154 of the optical receiver 150, based on the estimated polarization fluctuation frequency. In this case, it is considered that the digital signal processing unit 154 can accurately compensate for the polarization fluctuation occurring in the transmission line 130.

In the above explanation, an example in which the polarimeter 181 is used for measuring the Stokes parameter has been explained. However, the present example embodiment is not limited to this. The measurement of the Stokes parameter may be performed by using an apparatus having a polarizer, a photodetector, and a computing unit.

FIG. 14 illustrates a configuration example of an apparatus to be used for measurement of a Stokes parameter. The Stokes parameter measuring apparatus 181a includes a splitter 301, polarizers 302 to 304, a quarter-wave plate 305, photodetectors 311 to 314, an ADC 320, and a computing unit 330. The splitter 301 branches the optical signal being output from the light source 171, which is branched from the optical fiber 132, into four optical signals. The photodetector 311 detects an optical signal being input from the splitter 301, and converts the detected optical signal into an electrical signal V0.

The polarizer 302 passes a component of the optical signal being input from the splitter 301 in a direction orthogonal to the main axis to the photodetector 312. The photodetector 312 detects an optical signal that has passed through the polarizer 302, and converts the detected optical signal into an electrical signal V1. The polarizer 303 passes a component of the optical signal being input from the splitter 301 in a direction inclined by 45 degrees with respect to the main axis to the photodetector 313. The photodetector 313 detects an optical signal that has passed through the polarizer 303, and converts the detected optical signal into an electrical signal V2.

The quarter-wave plate 305 imparts a 90 degree (λ/4) phase difference to the two orthogonal polarized light components of the optical signal being input from the splitter 301. The polarizer 304 allows the photodetector 314 to pass a component of the optical signal being input via the quarter-wave plate 305 in a direction inclined by 45 degrees with respect to the main axis. The photodetector 314 detects an optical signal that has passed through the polarizer 304, and converts the detected optical signal into an electrical signal V3.

The ADC 320 converts the electrical signals V0 to V3 being output from the photodetectors 311 to 314 into digital signals. The computing unit 330 calculates one of the Stokes parameters S1 to S3 by using the V0 to V3 converted into digital signals by the ADC 320. The computing unit 330 calculates the Stokes parameter S1 by S1=2×V1−V0. The computing unit 330 calculates the Stokes parameter S2 by S2=2×V2−V0. The computing unit 330 calculates the Stokes parameter S3 by S3=2×V4−V0.

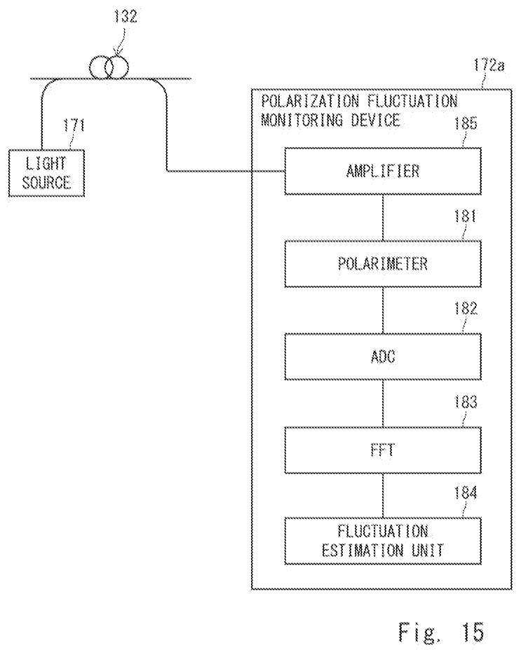

Next, a second example embodiment of the present disclosure will be explained. FIG. 15 illustrates a configuration example of a polarization fluctuation monitoring apparatus used in a second communication system according to the present disclosure. A polarization fluctuation monitoring apparatus 172a includes an amplifier 185 in addition to the configuration of the polarization fluctuation monitoring apparatus 172 illustrated in FIG. 6. Operations of a polarimeter 181, an ADC 182, a FFT 183, and a fluctuation estimation unit 184 in the polarization fluctuation monitoring apparatus 172a may be the same as those described in the first example embodiment.

The amplifier 185 is an optical amplifier, and amplifies an optical signal, which is transmitted through an optical fiber 132 and output from a light source 171. The polarimeter 181 measures a polarization characteristic of the optical signal amplified by the amplifier 185. In the present example embodiment, the optical signal is amplified by the amplifier 185. Therefore, power of the optical signal to be inserted into the optical fiber 132 from the light source 171 can be lower compared with the first example embodiment.

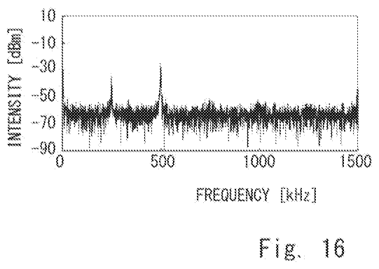

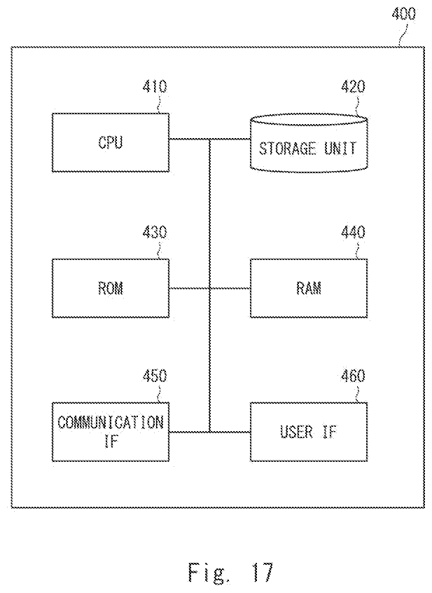

In the system illustrated in FIG. 7, the present inventor has conducted experiments by using a system having an amplifier between a scrambler 540 and a polarimeter 550. A gain of the amplifier has been set to 20 dB. FIG. 16 illustrates a FFT waveform of a Stokes parameter S1 acquired in the experiment. In a graph illustrated in FIG. 16, the horizontal axis represents a frequency [kHz], and the vertical axis represents intensity [dBm].

In the experiment, the scrambler 540 has imparted a polarization fluctuation of 500 kHz to the optical signal. By adjusting an attenuation amount of an attenuator 520, received light power of the polarimeter 550 has been adjusted to −60 dBm. In this case, as illustrated in FIG. 16, a peak has been observed at a position of 500 kHz in the FFT waveform of the Stokes parameter S1. As a result of the experiment, it has been confirmed that a polarization fluctuation speed can be estimated even when the power of the optical signal inserted into the optical fiber 132 is lower compared with the first example embodiment. Therefore, in the present example embodiment, it is possible to further suppress deterioration in reception quality of a main signal caused by the optical signal inserted into the optical fiber 132 from the light source 171.

The polarization fluctuation monitoring apparatus, the communication system, the polarization fluctuation monitoring method, and the program according to the present disclosure can accurately estimate the polarization fluctuation frequency without requiring complicated calculation.

FIG. 17 illustrates a configuration example of a computer apparatus that can be used as the polarization fluctuation monitoring apparatus 172. A computer apparatus 400 includes a central processing unit (CPU) 410, a storage unit 420, Read Only Memory (ROM) 430, Random Access Memory (RAM) 440, a communication interface (IF) 450, and a user interface 460.

The communication interface 450 is an interface used for communication with an external apparatus. The communication interface 450 may be used in order to acquire four sequences of received signals to be output from the ADC 153. The user interface 460 includes a display unit such as a display. The user interface 460 includes an input unit such as a keyboard, a mouse, and a touch panel.

The storage unit 420 is an auxiliary storage device capable of holding various types of data. The storage unit 420 is not necessarily a part of the computer apparatus 400, and may be an external storage device or a cloud storage connected to the computer apparatus 400 via a network.

The ROM 430 is a nonvolatile storage device. For example, a semiconductor storage device such as a flash memory having a relatively small capacity is used for the ROM 430. The program to be executed by the CPU 410 may be stored in the storage unit 420 or the ROM 430. The storage unit 420 or the ROM 430 stores various programs for causing the CPU 410 to perform processing for performing distortion compensation and detection.

The above program includes instructions (or software codes) that, when loaded into a computer, cause the computer to perform one or more of the functions described in the example embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a Compact Disc (CD), a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The RAM 440 is a volatile storage device. Various types of semiconductor memory devices such as Dynamic Random Access Memory (DRAM) and Static Random Access Memory (SRAM) are used for the RAM 440. The RAM 440 may be used as an internal buffer for temporarily storing data and the like. The CPU 410 loads a program stored in the storage unit 420 or the ROM 430 into the RAM 440 and executes the program. The CPU 410 may have an internal buffer capable of temporarily storing data and the like.

In each of the above-described example embodiments, the polarization fluctuation monitoring apparatus 172 is not necessarily configured as a single apparatus. The polarization fluctuation monitoring apparatus 172 may be configured by using a plurality of physically separated apparatuses. For example, the functions of the FFT 183 and the fluctuation estimation unit 184 may be achieved by software processing in a single computer apparatus. In that case, the computer apparatus may acquire the Stokes parameter from the polarimeter 181 via the ADC 182.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. Each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### Supplementary Note 1

A polarization fluctuation monitoring apparatus including:
a polarization characteristic measuring unit configured to measure a polarization characteristic of an optical signal transmitted through a transmission line;
a Fourier transform unit configured to Fourier-transform the measured polarization characteristic; and
a fluctuation estimation unit configured to estimate a polarization fluctuation frequency occurring in the transmission line, based on the Fourier-transformed polarization characteristic.

### Supplementary Note 2

The polarization fluctuation monitoring apparatus according to supplementary note 1, wherein the fluctuation estimation unit searches for a peak in the Fourier-transformed polarization characteristic, and estimates a frequency of a position of the searched peak as the polarization fluctuation frequency.

### Supplementary Note 3

The polarization fluctuation monitoring apparatus according to supplementary note 1 or 2, further including an amplifier configured to amplify the optical signal and output an amplified optical signal to the polarization characteristic measuring unit.

### Supplementary Note 4

The polarization fluctuation monitoring apparatus according to any one of supplementary notes 1 to 3, wherein the polarization characteristic measuring unit measures one of the Stokes parameters as the polarization characteristic.

### Supplementary Note 5

The polarization fluctuation monitoring apparatus according to supplementary note 4, wherein the polarization characteristic measuring unit is a polarimeter.

### Supplementary Note 6

The polarization fluctuation monitoring apparatus according to supplementary note 4, wherein the polarization characteristic measuring unit includes a polarizer configured to transmit a component of the optical signal in a predetermined polarization direction, a photodetector configured to detect an optical signal transmitted through the polarizer, and a computing unit configured to compute one of the Stokes parameters, based on the optical signal detected by using the photodetector.

### Supplementary Note 7

The polarization fluctuation monitoring apparatus according to any one of supplementary notes 1 to 6, wherein the optical signal is a signal having a wavelength different from a wavelength of a polarization multiplexed signal transmitted and received between an optical transmitter and an optical receiver, the signal being transmitted through the transmission line.

### Supplementary Note 8

The polarization fluctuation monitoring apparatus according to any one of supplementary notes 1 to 7, wherein the optical signal is inserted into the transmission line by using a multiplexer, and is branched from the transmission line by using a demultiplexer.

### Supplementary Note 9

The polarization fluctuation monitoring apparatus according to supplementary note 8, wherein the optical signal is inserted into the transmission line, transmitted over a predetermined span of the transmission line, and then branched from the transmission line.

### Supplementary Note 10

A communication system including:
a transmitter configured to transmit a polarization multiplexed signal;
a receiver configured to receive a polarization multiplexed signal transmitted from the transmitter through a transmission line;
the polarization fluctuation monitoring apparatus according to any one of supplementary notes 1 to 9; and
a light source configured to output the optical signal to the transmission line.

### Supplementary Note 11

The communication system according to supplementary note 10, the communication system includes a set of the polarization fluctuation monitoring apparatus and the light source for each predetermined span in the transmission line.

### Supplementary note 12

The communication system according to supplementary note 10 or 11, wherein
the receiver includes a polarization fluctuation compensation filter configured to compensate for polarization fluctuation in the transmission line, and
the polarization fluctuation monitoring apparatus controls a coefficient of the polarization fluctuation compensation filter, based on the estimated polarization fluctuation frequency.

### Supplementary Note 13

A polarization fluctuation monitoring method including:
measuring a polarization characteristic of an optical signal transmitted through a transmission line;
Fourier-transforming the measured polarization characteristic; and
estimating a polarization fluctuation frequency occurring in the transmission line, based on the Fourier-transformed polarization characteristic.

### Supplementary Note 14

A program for causing a computer to execute processing of:
acquiring a polarization characteristic of an optical signal transmitted through a transmission line;
Fourier-transforming the acquired polarization characteristic; and
estimating a polarization fluctuation frequency occurring in the transmission line, based on the Fourier-transformed polarization characteristic.

Some or all of elements (e.g., structures and functions) specified in Supplementary Notes 2 to 9 dependent on Supplementary Note 1 may also be dependent on Supplementary Note 13, and Supplementary Note 14 in dependency similar to that of Supplementary Notes 2 to 9 on Supplementary Note 1. Some or all of elements specified in any of Supplementary Notes may be applied to various types of hardware, software, and recording means for recording software, systems, and methods.

What is claimed is:

1. A polarization fluctuation monitoring apparatus comprising:
at least one memory storing instructions, and
at least one processor configured to execute the instructions to:
measure a polarization characteristic of an optical signal transmitted through a transmission line;
Fourier-transform the measured polarization characteristic; and
estimate a polarization fluctuation frequency occurring in the transmission line, based on the Fourier-transformed polarization characteristic.

2. The polarization fluctuation monitoring apparatus according to claim 1, wherein the at least one processor is configured to execute the instructions to:
search for a peak in the Fourier-transformed polarization characteristic, and
estimate a frequency of a position of the searched peak as the polarization fluctuation frequency.

3. The polarization fluctuation monitoring apparatus according to claim 1, further comprising amplifying the optical signal and outputting an amplified optical signal.

4. The polarization fluctuation monitoring apparatus according to claim 1, wherein the at least one processor is configured to execute the instructions to measure one or more of Stokes parameters as the polarization characteristic.

5. The polarization fluctuation monitoring apparatus according to claim 4, wherein the polarization characteristic is measured by a polarimeter.

6. The polarization fluctuation monitoring apparatus according to claim 4, the polarization fluctuation monitoring apparatus further comprising:
a polarizer configured to transmit a component of the optical signal in a predetermined polarization direction; and
a photodetector configured to detect an optical signal transmitted through the polarizer,
wherein the at least one processor is configured to execute the instructions to compute one or more of the Stokes parameters, based on an optical signal detected by using the photodetector.

7. The polarization fluctuation monitoring apparatus according to claim 1, wherein the optical signal is a signal having a wavelength different from a wavelength of a polarization multiplexed signal transmitted and received between an optical transmitter and an optical receiver, the signal being transmitted through the transmission line.

8. The polarization fluctuation monitoring apparatus according claim 1, wherein the optical signal is inserted into the transmission line by using a multiplexer, and is branched from the transmission line by using a demultiplexer.

9. The polarization fluctuation monitoring apparatus according to claim 8, wherein the optical signal is inserted into the transmission line, transmitted over a predetermined span of the transmission line, and then branched from the transmission line.

10. A communication system comprising:
a transmitter configured to transmit a polarization multiplexed signal;
a receiver configured to receive a polarization multiplexed signal transmitted from the transmitter through a transmission line;
the polarization fluctuation monitoring apparatus according to claim 1; and
a light source configured to output the optical signal to the transmission line.

11. The communication system according to claim 10, the communication system comprises a set of the polarization fluctuation monitoring apparatus and the light source for each predetermined span in the transmission line.

12. The communication system according to claim 10, wherein
the receiver comprises a polarization fluctuation compensation filter configured to compensate for polarization fluctuation in the transmission line, and
the polarization fluctuation monitoring apparatus controls a coefficient of the polarization fluctuation compensation filter, based on the estimated polarization fluctuation frequency.

13. A polarization fluctuation monitoring method comprising:
measuring a polarization characteristic of an optical signal transmitted through a transmission line;
Fourier-transforming the measured polarization characteristic; and
estimating a polarization fluctuation frequency occurring in the transmission line, based on the Fourier-transformed polarization characteristic.

14. A non-transitory computer readable medium storing a program for causing a computer to execute processing of:
acquiring a polarization characteristic of an optical signal transmitted through a transmission line;
Fourier-transforming the acquired polarization characteristic; and
estimating a polarization fluctuation frequency occurring in the transmission line, based on the Fourier-transformed polarization characteristic.
